(19) United States
(12) Patent Application Publication
(10) Pub. No.: US 2011/0185768 A1
(43) Pub. Date: Aug. 4, 2011

(54) DECORATIVE JEWELRY DOUBLE CLASP WITH SINGLE SPRING FOR BRACELETS & NECKLACES

(76) Inventor: Anna Pinchuk, Washington, DC (US)

(21) Appl. No.: 13/017,315

(22) Filed: Jan. 31, 2011

Related U.S. Application Data
(60) Provisional application No. 61/336,996, filed on Jan. 29, 2010.

(51) Int. Cl. A44C 5/18; F16B 2/10

(52) U.S. Cl. 63/3.1; 24/494

(57) ABSTRACT

A decorative double-sided jewelry clasp for joining two ends of a jewelry chain together. The clasp comprises a rocker plate pivotally mounted to a base plate at a hinge. The hinge is formed by cooperating yokes extending from the center of each of the rocker plate and base plate. With plates facing, the yokes align and a pin is inserted there through to pivotally secure them together. A torsion spring is carried on the pin to bias the rocker plate versus the base plate. Further, the base plate has a short post at one end and a longer hook at the other, the hook looping around to the backside of the rocker plate, and thereby stopping counter-pivoting of the rocker plate. Both hook and post catch and secure the ends of the jewelry chain, with the spring locking the chain at both ends until a user depresses the rocker plate, thereby counter-biasing it open at both ends to release the chain.

### CROSS REFERENCE TO RELATED APPLICATIONS

The present application derives priority from U.S. provisional application 61/336,996 filed 29 Jan. 2010 which is incorporated herein by reference.

### BACKGROUND OF THE INVENTION

1. Field of the Invention

The present invention relates generally to jewelry clasps and, more particularly to a single-action double clasp for attaching bracelet and necklace chains in a loop using a single spring.

2. Description of the Background

Clasping devices for necklaces, bracelets and other looped jewelry are well known in the art. They range from a very simple split-ring construction and operation, to more complex double-locking clasps. Most all such jewelry clasps are used to connect the free ends of necklace chains, bracelet chains, ankle chains, and the like. The very nature of these clasps and their use with delicate aesthetic chains commands a very small, delicate ornamental appearance, with tiny but stable and secure double-locking means for both ends of the chain. Security is paramount because these clasps in many cases hold extremely valuable diamond, silver, gold, pearls, etc. The delicate nature of these clasps makes opening and closing difficult, and struggling with the clasp can easily break the jewelry chain under the strain of opening. The locking mechanism must therefore achieve a balance between simple and delicate aesthetics, versus high-strength and simple and easy operation

For example, U.S. Pat. No. 4,314,389 to Sauer et al. issued Feb. 9, 1982 shows a double fold over jewelry clasp for securing opposite ends of a necklace chain, and more particularly to a double fold over jewelry clasp providing two sets of interlocking fastening means. However, each set of interlocking fastening means is completely independent of the other, and as such requires double the effort to remove both ends of the chain. There are twice as many moving parts to break, and double the complexity and obtrusiveness in appearance. Moreover, the two interlocking fastener are compression fittings which require significant dexterity to manipulate. Compression fittings are not well suited for very fine smaller jewelry. If the metal yokes fail are too small they tend to break.

U.S. Pat. No. 6,604,381 by Haber issued Aug. 12, 2003 shows a jewelry clasp having two members secured to one another. Similarly, U.S. Pat. No. 2,462,425 to Pratt, et.al. discloses a clasp for securing the ends of a flexible strand of jewelry such as a snake chain to each other. In both cases the locking element of the clasp is hinged and more easily manipulated, but only for one side of the chain to be clasped. What is needed is a jewelry clasp for securing opposing ends of a chain with a single spring-biased hinge and double-locking clasp.

### SUMMARY OF THE INVENTION

It is, therefore, a primary object of the present invention to provide a jewelry clasp that uses a single-pivot spring-biased hinge for double-sided locking of opposing ends of a chain together. Another object of the present invention is to provide a double-sided jewelry clasp with a fine, delicate and ornamental appearance, but which is highly stable and secure.

It is still another object of the present invention to provide a double-sided jewelry clasp with a simplified mechanism using minimal moving parts (four), and which is simple and efficient to manipulate.

It is still another object to provide a double-sided jewelry clasp with no fragile parts or stress points prone to breakage.

In accordance with the foregoing objects, the present invention is a double-sided jewelry clasp having a rocker plate pivotally mounted to a base plate at a spring-biased hinge. The hinge comprises a pair of opposing yokes extending from the center of each of the rocker plate and base plate. With the rocker plate facing the base plate, the yokes align and a pin is inserted through distal apertures in all of the yokes to pivotally secure them together. A torsion spring is carried on the pin to bias the rocker plate versus the base plate. Further, the base plate has a hook at one end and a post at the other. The post acts as a stop against the pivoting of the rocker plate, and as a yoke for insertion of one end of a necklace or other chain. Thus, when the rocker plate is pivoted tight against the necklace chain is held captive on the post. The hook loops around to the backside of the rocker plate, and thereby acts as a stop against the counter-pivoting of the rocker plate. Likewise, the hook serves as a yoke for insertion of the other end of the necklace. Thus, when the rocker plate is counter-pivoted tight against the hook the necklace chain is held captive on the hook. Given a spring-bias the rocker plate will seat against both the post and hook, locking the necklace chain at both ends. A user need only depress the rocker plate to counter-bias it open at both ends, and thereby release both ends of the necklace chain. The foregoing configuration accomplishes a double-ended yoke/release with just a single-spring-biased hinge, minimal parts (four), and no stress points prone to breakage. The result is a double-sided jewelry clasp that is highly stable and secure, yet which presents a fine, delicate ornamental appearance. Moreover, it is simple and efficient to manipulate.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 is a side perspective view of the jewelry clasp 2 in an open position according to a preferred embodiment of the present invention.

FIG. 2 is an exploded perspective view of the jewelry clasp 2 as in FIG. 1 illustrating the attachment of a necklace chain.

FIG. 3 is a disassembled perspective view of the jewelry clasp 2 as in FIGS. 1-2.

FIG. 4 is a disassembled perspective view of a jewelry clasp 2 according to an alternate embodiment.

### DETAILED DESCRIPTION OF THE PREFERRED EMBODIMENT

The present invention is a jewelry clasp with a more efficient single-pivot spring-biased hinge for double-sided locking of opposing ends of a chain together.

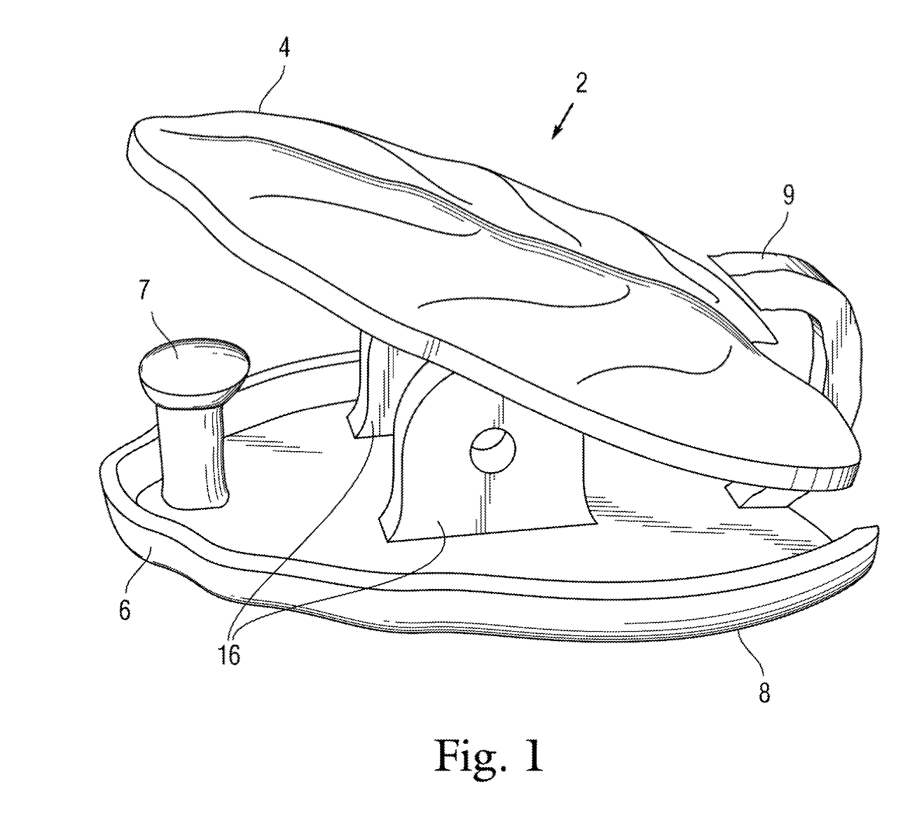

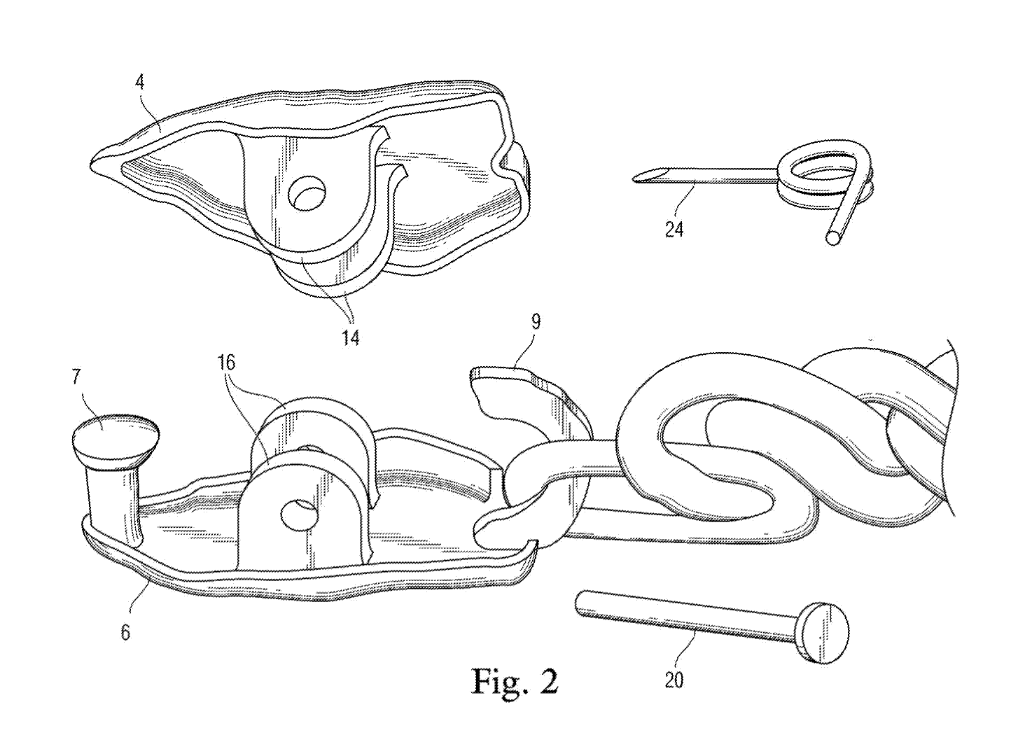

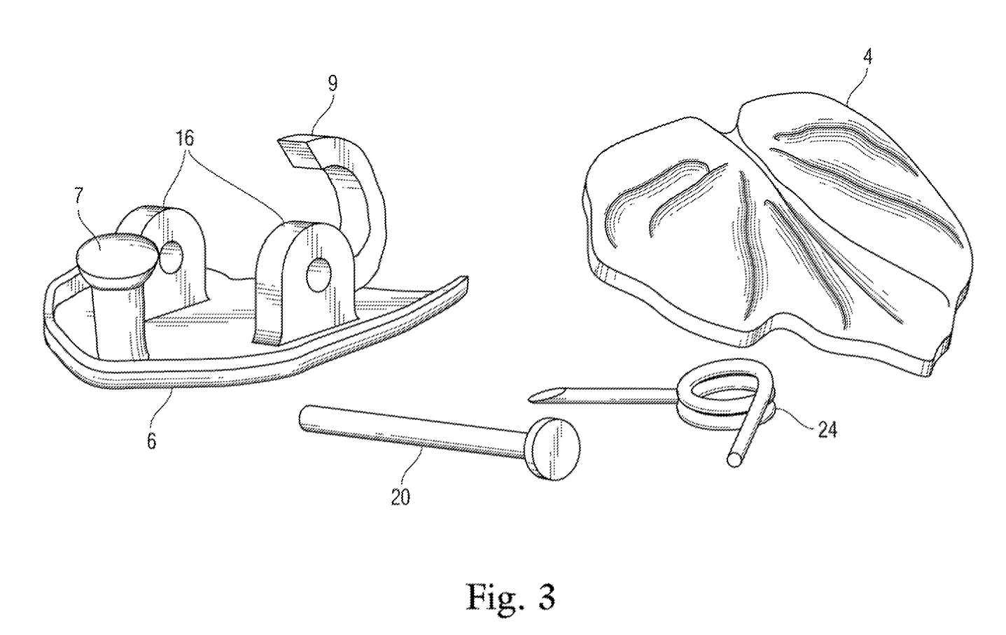

FIG. 1 shows a perspective view of an embodiment of the jewelry clasp 2 in an open position ready for insertion of both ends of a chain, while FIGS. 2-3 are exploded/disassembled views illustrating the individual components. With collective reference to FIGS. 1-3, the double-sided jewelry clasp 2 generally comprises a rocker plate 4 offset from and pivotally mounted atop a base plate 6 in a facing relation, at a centrally-located spring biased hinge 8. Both rocker plate 4 and base plate 6 may be formed in any of a variety of ornamental shapes, including complementary leaves as shown. They need not be uniform or flat, but must facilitate pivoting of rocker plate 4. The offset hinge 8 further comprises an opposing pair of yokes 14, 16 extending from the center of each of the rocker plate 4 and base plate 6, respectively. Each yoke 14, 16 may be generally formed as a flat U-shaped projection extending perpendicularly from the facing inner surfaces of the opposing rocker plate 4 and base plate 6, and having coaxially-aligned apertures defined through the curvilinear distal ends. The yokes 14, 16 of both rocker plate 4 and base plate 6 all have a uniformly defined width w, and the yokes 14 of the rocker plate 4 are laterally spaced by a distance d₁ that is slightly larger than the lateral spacing d₂ of the yokes 16 of the base plate 6, and specifically d₁=d₂+2w. Alternatively, the offset distance d₁ of the yokes 14 of the rocker plate 4 may be slightly smaller than offset distance d₂ of the yokes 16 of the base plate 6, or d₁+2w=d₂. This is to ensure that when the rocker plate 4 is brought together with the base plate 6 in a facing relation the yokes 14 of the rocker plate 4 will fit just inside or outside the yokes 16 of the base plate 6 so that all four apertures may be coaxially aligned. Otherwise, all of the yokes 14, 16 of both rocker plate 4 and base plate 6 are preferably uniformly shaped and dimensioned, and the yokes 14, 16 may be soldered, welded, adhered or integrally molded to the respective rocker plate 4 and base plate 6. With the rocker plate 4 facing the base plate 6, the yokes 14, 16 and apertures come into alignment and a pin 20 is inserted through the apertures in all four of the yokes 14, 16 to pivotally secure them together. A torsion spring 24 is carried on the pin 20 between the opposing yokes 14, 16 to bias the rocker 4 plate relative to the base plate 6. The torsion spring 24 is formed with one or more resilient coils wound about the pin 20 and extending to two protruding legs that are long enough so that one abuts the rocker plate 4 and one the base plate 6. The base plate has a hook 9 at one end and a post 7 at the other, both hook 9 and post 7 likewise being soldered, welded, adhered or integrally molded to the base plate 6. The post 7 projects upward to a distal inwardly-angled elbow or tip which both stops the pivoting of the rocker plate 4, and also forms a catch form anchoring one link of a necklace or chain. Preferably, post 7 is formed with a pronounced and flattened distal tip as shown that provides a contoured bearing surface against the opposing rocker plate 4 and also prevent the necklace or chain from coming off inadvertently (see FIG. 3). In an unbiased position the rocker plate 4 is pivoted by spring 20 tight against the post 7, and the necklace chain is thereby held captive on the post 7. On the other side, the hook 9 loops around and overtop the rocker plate 4, bearing against the edge and/or backside of the rocker plate 4 and thereby acting as a stop against the counter-pivoting of the rocker plate 4. The rocker plate 4 is preferably formed with a central notch or groove at its peripheral edge to seat the tip of the hook 9. As with the post 7, the hook 9 likewise serves as a catch for holding captive the other end-link of the necklace. Thus, when the rocker plate 4 is counter-pivoted tight against the hook 9 the necklace chain is held captive on the hook 9.

In operation, given the spring-bias of spring 20 the rocker plate 4 will naturally seat against both the post 8 and hook 9, locking the necklace chain at both ends. A user need only depress the rocker plate 4 by clamping the distal ends (proximate hook 9) together in their fingers, thereby counter-biasing the clasp 2 open at both ends. Both ends of the necklace chain can be conveniently released and removed from the hook 9 and post 7.

The foregoing configuration accomplishes a double-ended yoke/release with just a single-spring-biased hinge 8, minimal parts (four), and importantly, no stress points prone to breakage. The result is a double-sided jewelry clasp 2 that is highly stable and secure, yet which presents a fine, delicate ornamental appearance. Moreover, the clasp 2 is extremely simple and efficient to open and close.

One skilled in the art should readily understand that features of the double-sided jewelry clasp 2 may be altered without sacrificing the utility of the jewelry clasp 2. For example, the hook 9 and/or post 7 may be extended from either the base plate 6 or rocker plate 4, or one from each of the base plate 6 and rocker plate 4.

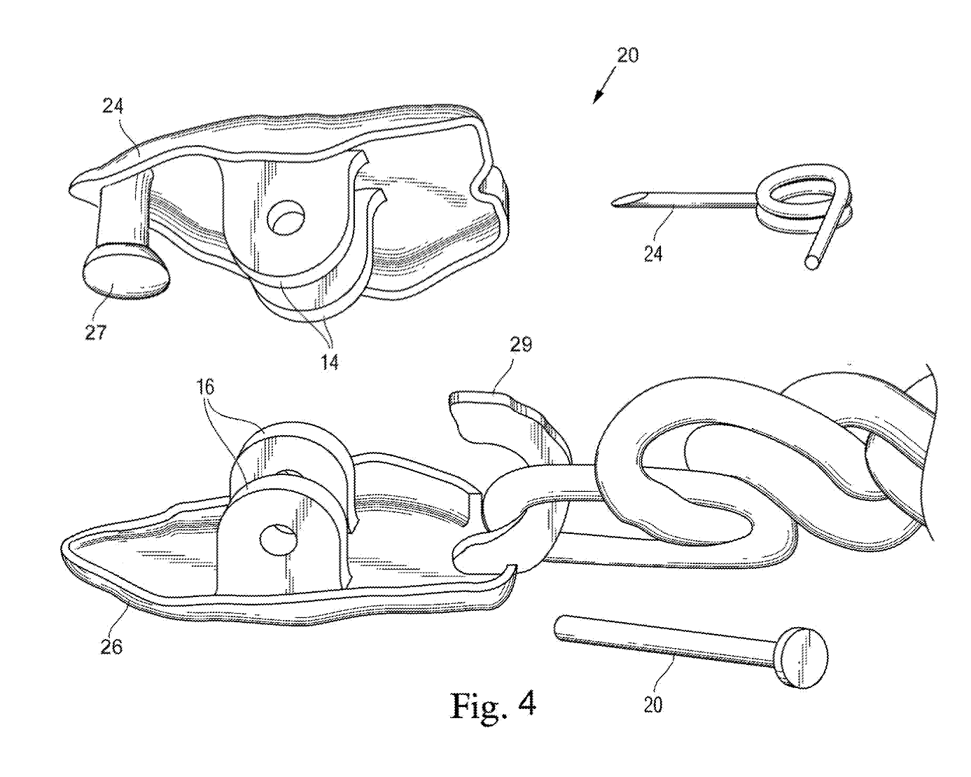

As an example, FIG. 4 is a disassembled perspective view of a jewelry clasp 20 according to an alternate embodiment in which hook 29 extends from base plate 26 and post 27 extends from rocker plate 24,

The above-described embodiments are for the purpose of promoting an understanding of the principles of the invention. It should nevertheless be understood that no limitation of the scope of the invention is thereby intended, such alternations and further modifications in the illustrated device, and such further applications of the principles of the invention as illustrated herein being contemplated as would normally occur to one skilled in the art to which the invention relates.

I claim:

1. A double-sided jewelry clasp, comprising:
a base plate having a centrally-positioned pair of laterally-offset yokes protruding perpendicularly from one side of said base plate;
a rocker plate having a centrally-positioned pair of laterally-offset yokes protruding perpendicularly from one side of said rocker plate, and pivotally mounted to said base plate by a pin traversing all of the yokes of said base plate and rocker plate;
a torsion spring mounted on said pin between all of the yokes of said base plate and rocker plate;
a post extending transversely from one end of said base plate toward said rocker plate for holding one end of a jewelry chain captive; and
a hook extending transversely from an opposing end of said base plate toward said rocker plate, and angled around and over another side of said rocker plate for holding another end of said jewelry chain captive;
whereby a user may squeeze the rocker plate against the base plate at one end to bias it open at both ends, and thereby allowing release of both ends of said jewelry chain.

2. The double-sided jewelry clasp according to claim 1, wherein the yokes of both said rocker plate and base plate all have a uniformly defined width.

3. The double-sided jewelry clasp according to claim 2, wherein the yokes of said rocker plate are laterally spaced by a first distance and the yokes of said rocker plate are laterally spaced by a second distance, said second distance being slightly greater than said first distance.

4. The double-sided jewelry clasp according to claim 2, wherein the yokes of said rocker plate are laterally spaced by a first distance and the yokes of said rocker plate are laterally spaced by a second distance, said second distance being slightly smaller than said first distance.

5. The double-sided jewelry clasp according to claim 2, wherein the yokes of both said rocker plate and base plate all have a uniformly defined width w, the yokes of said rocker plate are laterally spaced by a first distance d₁, the yokes of said rocker plate are laterally spaced by a second distance d₂, and d₁ is substantially equal to d₂+2w.

6. The double-sided jewelry clasp according to claim 2, wherein the yokes of both said rocker plate and base plate all have a uniformly defined width w, the yokes of said rocker plate are laterally spaced by a first distance d₁, the yokes of said rocker plate are laterally spaced by a second distance d₂, and d₁ is substantially equal to d₂−2w.

7. The double-sided jewelry clasp according to claim 1, wherein said torsion spring is formed with one or more resilient coils wound about the pin and extends to two protruding legs, one leg extending to and abutting the rocker plate, and another leg extending to and abutting the base plate.

8. The double-sided jewelry clasp according to claim 1, wherein said post is formed with a pronounced and flattened distal tip to provide a contoured bearing surface against the opposing rocker plate.

9. The double-sided jewelry clasp according to claim 1, wherein said hook is formed with an inward arching curve around and over said other side of said rocker plate.

10. The double-sided jewelry clasp according to claim 9, wherein said rocker plate is formed with a peripheral notch at one end for seating said hook.

11. In combination with a jewelry chain having end links at opposing ends, a double-sided jewelry clasp, comprising:
a base plate having a pair of laterally-offset yokes protruding perpendicularly from one side of said base plate;
a rocker plate having a pair of laterally-offset yokes protruding perpendicularly from one side of said rocker plate, and pivotally mounted to said base plate by a pin traversing all of the yokes of said base plate and rocker plate;
a torsion spring mounted on said pin between all of the yokes of said base plate and rocker plate for pre-biasing said rocker plate open at one end and closed at another end relative to said base plate;
a post extending transversely from one end of said base plate toward said rocker plate for holding one end of a jewelry chain captive; and
a hook extending transversely from an opposing end of one of said base plate and rocker plate and extending toward the other of said base plate and rocker plate, and angled there around and over for holding another end of said jewelry chain captive;
whereby a user may squeeze the rocker plate against the base plate at one end to bias it open at both ends, and thereby allowing release of both ends of said jewelry chain.

12. The double-sided jewelry clasp according to claim 11, wherein the yokes of both said rocker plate and base plate all have a uniformly defined width.

13. The double-sided jewelry clasp according to claim 12, wherein the yokes of said rocker plate are laterally spaced by a first distance and the yokes of said rocker plate are laterally spaced by a second distance, said second distance being slightly greater than said first distance.

14. The double-sided jewelry clasp according to claim 12, wherein the yokes of said rocker plate are laterally spaced by a first distance and the yokes of said rocker plate are laterally spaced by a second distance, said second distance being slightly smaller than said first distance.

15. The double-sided jewelry clasp according to claim 12, wherein the yokes of both said rocker plate and base plate all have a uniformly defined width w, the yokes of said rocker plate are laterally spaced by a first distance d₁, the yokes of said rocker plate are laterally spaced by a second distance d₂, and d₁ is substantially equal to d₂+2w.

16. The double-sided jewelry clasp according to claim 12, wherein the yokes of both said rocker plate and base plate all have a uniformly defined width w, the yokes of said rocker plate are laterally spaced by a first distance d₁, the yokes of said rocker plate are laterally spaced by a second distance d₂, and d₁ is substantially equal to d₂−2w.

17. The double-sided jewelry clasp according to claim 11, wherein said torsion spring is formed with one or more resilient coils wound about the pin and extends to two protruding legs, one leg extending to and abutting the rocker plate, and another leg extending to and abutting the base plate.

18. The double-sided jewelry clasp according to claim 11, wherein said post is formed with a pronounced and flattened distal tip to provide a contoured bearing surface against the opposing rocker plate.

19. The double-sided jewelry clasp according to claim 11, wherein said hook is formed with an inward arching curve around and over the opposing rocker plate or base plate.

20. The double-sided jewelry clasp according to claim 19, wherein one of said rocker plate and base plate is formed with a peripheral notch at one end for seating said hook.
